(19) United States
(12) Patent Application Publication
(10) Pub. No.: US 2002/0150169 A1
(43) Pub. Date: Oct. 17, 2002

(54) Apparatus and method for measuring propagation delay in an NB-TDD CDMA mobile communication system

(75) Inventor: Takahiko Kishi, Yokohama (JP)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/124,212

(22) Filed: Apr. 16, 2002

(30) Foreign Application Priority Data
Apr. 16, 2001 (JP) 2001-116827
Apr. 16, 2001 (JP) 2001-116828

(51) Int. Cl. H04L 27/04; H04L 27/12; H04L 27/20

(52) U.S. Cl. 375/295

(57) ABSTRACT

A transmitter for data communication capable of reducing generation of spurious signals without an increase in a ROM size of a DDS (Direct Digital Synthesizer), which causes an increase in power consumption, and without restricting a transmission frequency. The transmitter comprises a first mixer for converting an output of a modulator to a first IF (Intermediate Frequency) signal using a first local signal generator; a digital filter for suppressing a predetermined out-band signal among the first IF signal; and a second mixer for D/A (Digital-to-Analog)-converting an output of the digital filter, and converting the D/A-converted signal to a second analog IF signal or RF (Radio Frequency) signal using a second local signal generator. A frequency step of the first local signal generator is less than a frequency step of the second local signal generator.

### PRIORITY

This application claims priority to an application entitled “Transmitter for Data Communication” filed in the Japanese Patent Office on Apr. 16, 2001 and assigned Serial No. 2001-116827, and an application entitled “Transmitter for Data Communication” filed in-the Japanese Patent Office on Apr. 16, 2001 and assigned Serial No. 2001-116828, the contents of both of which are hereby incorporated by reference.

### BACKGROUND OF THE INVENTION

1. Field of the Invention

The present invention relates generally to a radio communication apparatus used for data communication, and in particular, to a transmitter with a digital up-converter serving as a frequency converter for converting an input signal to an RF (Radio Frequency) signal or an IF (Intermediate Frequency) signal.

2. Description of the Related Art

A typical structure of a conventional radio transmitter for data communication is illustrated in FIG. 15. Referring to FIG. 15, the radio transmitter for data communication includes a digital up-converter (DUC) 360, digital-to-analog converters (DACs) 341 and 342, a second mixer 350, and a PLL (Phase Locked Loop) 343. The digital up-converter 360 is comprised of a filter 310, an interpolation filter 320, a first mixer 330, and a direct digital synthesizer (DDS) 340. The filter 310 is comprised of roll-off filters 311 and 312 receiving output signals of a modulator 300, which quadrature-modulates input digital data and outputs a baseband signal comprised of an in-phase component signal I and a quadrature-phase component signal Q. The interpolation filter 320 is comprised of an up-sampler 321, a bandpass filter 323, an up-sampler 322, and a bandpass filter 324. The first mixer 330 is comprised of multipliers 331-334, an adder 336, and a subtracter 335. The direct digital synthesizer 340 serves as a local signal generator used for frequency conversion by the first mixer 330.

Further, the second mixer 350 is comprised of multipliers 351 and 352, and an adder 353. The PLL 343 provides the multipliers 351 and 352 with local oscillation signals.

In operation, the roll-off filters 311 and 312 remove unnecessary frequency components from the I-component signal and the Q-component signal of the baseband signal output from the modulator 300, and provide their output signals to the interpolation filter 320. The interpolation filter 320 converts a sampling frequency of the baseband signal to a sampling frequency with a high sampling rate.

The multipliers 331-334 of the first mixer 330 convert frequencies of the I signal and the Q signal from the interpolation filter 320 using the local oscillation signals output from the DDS 340. The output of the multiplier 334 is subtracted from the output of the multiplier 331 by the subtracter 335. The output of the multiplier 332 is added to the output of the multiplier 333 by the adder 336. The outputs of the subtracter 335 and the adder 336 are subject to digital-to-analog conversion by the DACs 341 and 342, respectively. The outputs of the DACs 341 and 342 are converted to an RF signal or IF signal having a desired frequency by the second mixer 350 using the local oscillation signals output from the PLL 343.

A spurious signal generated due to an operation error of the DDS serving as a local signal generator generating the local oscillation signals for the mixer in the radio transmitter of FIG. 15 for frequency-converting the baseband signal to an RF signal or IF signal by digital signal processing, deteriorates an adjacent channel leakage characteristic and out-band spurious radiation characteristic as is explained in conjunction with the simulation results illustrated in FIGS. 16 to 20. Therefore, measures have been taken to increase operation accuracy of reducing generation of the spurious signals by the local signal generator to a permissible level or to suppress generation of the spurious signals.

The simulation results of the conventional radio transmitter for data communication, illustrated in FIGS. 16 to 20, were obtained when sampling frequencies are Fs1=Fs2=64 Hz, a transmission frequency is 15.02 Hz, a phase operation word of the DDS has a 32-bit length, a ROM has a 1-Kword size, the ROM has a 16-bit output length, n=1, and a frequency step of the PLL is 2 Hz.

FIG. 7 illustrates a detailed structure of a DDS used as a local signal generator. The DDS includes an adder 200 for adding phase information Δφ with an operation word length j to an output of a phase register 201, the phase register 201 for temporarily maintaining an output of the adder 200 and feeding its output back to the adder 200, and a ROM 203 in which amplitude information is stored in association with the output data of the phase register 201. That is, the ROM 203 serves as a phase-to-amplitude converter.

In operation, the phase information Δφ with the operation word length j is added to the output of the phase register 201 by the adder 200. The output of the adder 200 is provided to the phase register 201 where it is temporarily maintained. The output of the phase register 201 is converted into sine/cosine waves by the ROM 203. Here, adders 202 and 204 are virtually provided to indicate that a phase requantization error eₚ and an amplitude quantization error eₐ are mixed with the signal. Thus, the adders 202 and 204 are not the elements of the DDS.

The spurious signal generated due to the low operation accuracy of the DDS illustrated in FIG. 7 is caused by (i) a phase requantization error eₚ determined by a difference between an operation word length j of the adder 200 and the phase register 201, constituting a phase data operator, and an address length (input word length) k of the ROM 203 for converting the phase data to sine/cosine waves, and (ii) an amplitude quantization error eₐ with an output bit length m from the ROM 203.

Setting j to be equal to k (j=k) for an improvement in the operation accuracy leads to suppression of the spurious signal caused by the phase requantization error. Further, an increase in the value m reduces generation of the spurious signal caused by the amplitude quantization error to a permissible level.

In order to suppress generation of the spurious signal, the following measures have been taken. First, the DDS suppresses generation of the spurious signal by injecting a signal having no relation to data of the DDS into the points where the phase requantization error eₚ and the amplitude quantization error eₐ are generated (dither method). Second, since generation of the spurious signal in the DDS depends upon the oscillation frequency, a frequency not causing generation of the spurious signal in the DDS is used. Third, the spurious signal is suppressed by inserting bandpass filters with a narrow bandwidth in output stages of the DACs 341 and 342 in the conventional radio transmitter for data communication illustrated in FIG. 15.

However, in the method of setting j to be equal to k (j=k) in the DDS, the value j is increased to a considerably large value when a subdivided frequency step is required. For example, if j=32 bits, a 4-Gword ROM size is required. This is not realistic in the DDS used for the communication field requiring high-speed operation, except as a special case.

In either method, the spurious signal is spread, so C/N is deteriorated. As a result, the DUC's problem caused by the spurious signal of the DDS is not improved.

The method of using the frequency not causing generation of the spurious signal of the DDS has a limitation in setting a frequency of the DDS, and requires a second local signal generator to set a subdivided frequency step. Further, when the PLL is used, it is difficult to secure a response time and C/N performance.

Further, the method of using the filters in the output stages of the DACs has a limitation on the frequencies output by the filters and also, increases the cost due to the use of the filters.

FIG. 21 illustrates a structure of a transmitter including a digital up-converter (DUC) 1370 serving as a frequency converter for a digital signal processing circuit in the conventional radio transmitter for data communication. Referring to FIG. 21, the digital up-converter 1370 includes a filter 1310, an interpolator 1320, a mixer 1330, and a direct digital synthesizer (DDS) 1334. The filter 1310 is comprised of roll-off filters 1311 and 1312 receiving output signals of a modulator 1300, which quadrature-modulates input digital data and outputs a baseband signal comprised of an in-phase component signal I and a quadrature-phase component signal Q. The interpolator 1320 is comprised of an up-sampler 1321, a bandpass filter 1323, an up-sampler 1322, and a bandpass filter 1324. The mixing section 1330 is comprised of mixers 1331 and 1332, and an adder 1333. The direct digital synthesizer 1334 serves as a local signal generator used for frequency conversion by the mixer 1330.

In operation, the roll-off filters 1311 and 1312 remove unnecessary frequency components from the I-component signal and the Q-component signal of the baseband signal output from the modulator 1300, and provide their output signals to the interpolator 1320. The interpolator 1320 converts a sampling frequency of the baseband signal to a sampling frequency with a high sampling rate. The mixers 1331 and 1332 of the mixing section 1330 convert frequencies of the I signal and the Q signal from the bandpass filters 1323 and 1324 in the interpolation filter 320 using local oscillation signals output from the DDS 1334. The output of the mixer 1331 is added to the output of the mixer 1332 by the adder 1333. The output of the adder 1333 is subject to digital-to-analog conversion by a DAC 1350, and then converted to an RF signal or IF signal having a desired frequency by a bandpass filter 1360.

A spurious signal generated due to an operation error of the DDS serving as a local signal generator generating the local oscillation signals for the mixer in the digital up-converter of FIG. 21 for frequency-converting the baseband signal to an RF signal or IF signal by digital signal processing, deteriorates an adjacent channel leakage characteristic and out-band spurious radiation characteristic as is explained in conjunction with the simulation results illustrated in FIGS. 22 to 24. Therefore, measures have been taken to increase operation accuracy of reducing generation of the spurious signals by the local signal generator to a permissible level or to suppress generation of the spurious signal.

The simulation results of the conventional digital up-converter, illustrated in FIGS. 22 to 24, are obtained when sampling frequencies are Fs1=Fs2=64 Hz, a transmission frequency is 15.02 Hz, a phase operation word of the DDS has a 32-bit length, a ROM has a 1-Kword size, and the ROM has a 16-bit output length.

FIG. 14 illustrates a detailed structure of a DDS used as a local signal generator. The DDS includes an adder 1200 for adding phase information Δφ with an operation word length j to an output of a phase register 1201, the phase register 1201 for temporarily maintaining an output of the adder 1200 and feeding its output back to the adder 1200, and a ROM 1203 in which amplitude information is stored in association with the output data of the phase register 1201. That is, the ROM 1203 serves as a phase-to-amplitude converter.

In operation, the phase information Δφ with the operation word length j is added to the output of the phase register 1201 by the adder 1200. The output of the adder 1200 is provided to the phase register 1201 where it is temporarily maintained. The output of the phase register 1201 is converted into sine/cosine waves by the ROM 1203. Here, adders 1202 and 1204 are virtually provided to indicate that a phase requantization error eₚ and an amplitude quantization error eₐ are mixed with the signal. Thus, the adders 1202 and 1204 are not the elements of the DDS.

The spurious signal generated due to an operation error of the DDS illustrated in FIG. 14 is caused by (i) a phase requantization error eₚ determined by a difference between an operation word length j of the adder 1200 and the phase register 1201, constituting a phase data operator, and an address length (input word length) k of the ROM 1203 for converting the phase data to sine/cosine waves, and (ii) an amplitude quantization error eₐ with an output bit length m from the ROM 1203.

Setting j to be equal to k (j=k) for an improvement in the operation accuracy will lead to suppression of the spurious signal caused by the phase requantization error. Further, an increase in the value m will reduce generation of the spurious signal caused by the amplitude quantization error to a permissible level.

In order to suppress generation of the spurious signal, the following measures have been taken. First, the DDS suppresses generation of the spurious signal by injecting a signal having no relation to data of the DDS into the points where the phase requantization error eₚ and the amplitude quantization error eₐ are generated (dither method). Second, since generation of the spurious signal in the DDS depends upon the oscillation frequency, a frequency not causing generation of the spurious signal in the DDS is used. Third, the spurious signal is suppressed by the bandpass filter 1360 arranged at an output stage of the DAC 1350 in the conventional digital up-converter illustrated in FIG. 21.

However, in the method of setting j to be equal to k (j=k) in the DDS, the value j is increased to a considerably large value when a subdivided frequency step is required. For example, if j=32 bits, a 4-Gword ROM size is required. This is not realistic in the DDS used for the communication field requiring high-speed operation, except as a special case.

In either method, the spurious signal is spread, so C/N is deteriorated. As a result, the DUC's problem caused by the spurious signal of the DDS is not improved.

The method of using the frequency not causing generation of the spurious signal of the DDS has a limitation in setting a frequency of the DDS. Further, the method of using the filter in the output stage of the DAC has a limitation on the frequencies output by the filter and also, increases the cost due to the use of the filter.

### SUMMARY OF THE INVENTION

It is, therefore, an object of the present invention to provide a transmitter with a digital up-converter capable of reducing generation of spurious signals without an increase in a ROM size of a DDS, which causes an increase in power consumption, and without restricting a transmission frequency.

To achieve the above and other objects, the present invention provides a transmitter used for data communication, comprising a first mixer for converting an output of a modulator to a first IF (Intermediate Frequency) signal using a first local signal generator; a digital filter for suppressing a predetermined out-band signal among the first IF signal; and a second mixer for D/A (Digital-to-Analog) converting an output of the digital filter, and converting the D/A-converted signal to a second analog IF signal or RF (Radio Frequency) signal using a second local signal generator; wherein a frequency step of the first local signal generator is less than a frequency step of the second local signal generator.

The second local signal generator is comprised of a DSP (Digital Signal Processing)-based signal generator, and a PLL (Phase Locked Loop) operating based on an output of the signal generator.

The DSP-based signal generator constituting the first local signal generator and the second local signal generator is a direct digital synthesizer (DDS) outputting sine/cosine waves.

A phase operation word length of the direct digital synthesizer constituting the second local signal generator is equal to an input word length of a sine/cosine wave table for converting phase data to sine/cosine waves.

The DSP-based signal generator of the second local signal generator sequentially reads a sine/cosine wave table for converting phase data to sine/cosine waves. The sine/cosine wave table has a variable length. The sine/cosine wave table stores data of multiple periods. The digital filter is an interpolation filter.

The digital filter is a complex FIR (Finite Impulse Response) filter, and a complex BPF (Band Pass filter) coefficient for the complex FIR filter is calculated by multiplying a reference LPF (Low Pass Filter) coefficient of a real coefficient having a half bandwidth of a communication channel by e^{j(nω)}, where ω denotes an IF frequency of the first mixer, during a frequency setup.

When a stop band characteristic on the output of the first mixer at the filter can be bad and a passband frequency is not strictly calculated, the e^{j(nω)} value multiplied by the LPF coefficient is calculated by the first local signal generator.

When a stop band characteristic on the output of the first mixer at the filter must be good and a passband frequency is not strictly calculated, the e^{j(nω)} value multiplied by the LPF coefficient is calculated by the second local signal generator.

A sampling clock of the DSP-based signal generator in the second local signal generator is an output of a crystal signal generator.

Further, to achieve the above and other objects, the present invention provides a digital up-converter in a transmitter used for data communication, comprising a first mixer for converting an input signal to a first IF signal using a first local signal generator; a digital filter for suppressing a predetermined out-band signal among the first IF signal; and a second mixer for converting an output of the digital filter to an input frequency to an A/D converter using a second local signal generator; wherein a frequency step of the first local signal generator is less than a frequency step of the second local signal generator.

The first local signal generator and the second local signal generator each are comprised of a direct digital synthesizer (DDS) outputting sine/cosine waves.

A phase operation word length of the DDS serving as the second local signal generator is equal to an input word length of a sine/cosine wave table for converting phase data to sine/cosine wave.

The second local signal generator sequentially reads a sine/cosine wave table for converting phase data to sine/cosine waves and the sine/cosine wave table has a variable length. The sine/cosine wave table stores data of multiple periods.

Preferably, sampling frequency conversion is performed between the first mixer and the second mixer.

The digital filter is an interpolation filter, and increases a sampling frequency after the second mixer.

A bandwidth of the digital filter is calculated by adding an output frequency step of the second local signal generator to a bandwidth of a communication channel.

The digital filter is a complex FIR filter, wherein a complex BPF coefficient for the complex FIR filter is calculated by multiplying a reference LPF coefficient of a real coefficient having a half bandwidth of a communication channel by e^{j(nω)}, where ω denotes an IF frequency of the first mixer), during frequency setup.

When a stop band characteristic on the output of the first mixer at the filter can be bad and a passband frequency is not strictly calculated, the e^{j(nω)} value multiplied by the LPF coefficient is calculated by the first local signal generator.

When a stop band characteristic on the output of the first mixer at the filter must be good and a passband frequency is not strictly calculated, the e^{j(nω)} value multiplied by the LPF coefficient is calculated by the second local signal generator.

In this way, it is possible to implement a digital up-converter capable of reducing the generation of spurious signals without an increase in a ROM size of a DDS, which causes an increase in power consumption, and without restricting an output frequency.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a structure of a transmitter according to a first embodiment of the present invention;

FIG. 2 illustrates a simulation result on the output characteristics of the roll-off filters in the transmitter illustrated in FIG. 1;

FIG. 3 illustrates a simulation result on the output characteristic of the interpolation bandpass filter in the transmitter illustrated in FIG. 1;

FIG. 4 illustrates a simulation result on the output characteristic of the DDS used for a first mixer in the transmitter illustrated in FIG. 1;

FIG. 5 illustrates a simulation result on the output characteristic of the DDS used for the second mixer in the transmitter illustrated in FIG. 1;

FIG. 6 illustrates a simulation result on the output characteristic of the transmitter illustrated in FIG. 1;

FIG. 7 illustrates a detailed structure of the DDS used as the local signal generator for the mixer in the transmitter illustrated in FIG. 1;

FIG. 8 illustrates a structure of a transmitter according to a second embodiment of the present invention;

FIG. 9 illustrates a simulation result on the output characteristics of the roll-off filters in the transmitter illustrated in FIG. 8;

FIG. 10 illustrates a simulation result on the output characteristic of the interpolation bandpass filter in the transmitter illustrated in FIG. 8;

FIG. 11 illustrates a simulation result on the output characteristic of the DDS used for the first mixer in the transmitter illustrated in FIG. 8;

FIG. 12 illustrates a simulation result on the output characteristic of the DDS used for the second mixer in the transmitter illustrated in FIG. 8;

FIG. 13 illustrates a simulation result on the output characteristic of the transmitter illustrated in FIG. 8;

FIG. 14 illustrates a detailed structure of the DDS used as the local signal generator for the mixer in the transmitter illustrated in FIG. 8;

FIG. 15 illustrates a structure of a transmitter according to the prior art;

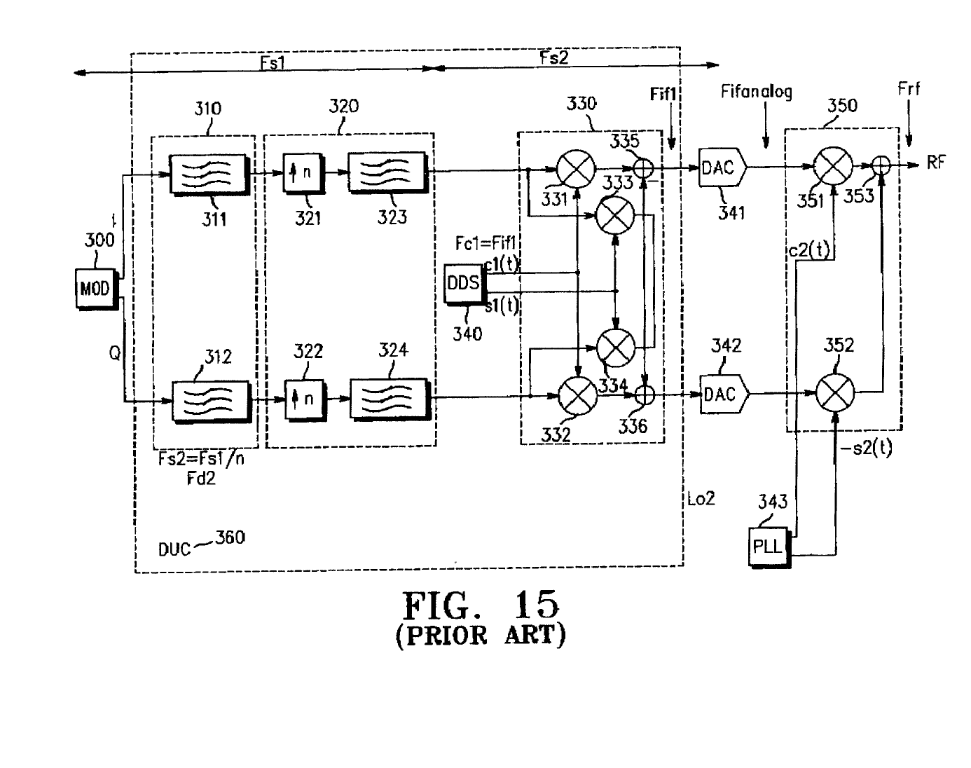

FIG. 16 illustrates a simulation result on the output characteristics of the roll-off filters in the transmitter illustrated in FIG. 15;

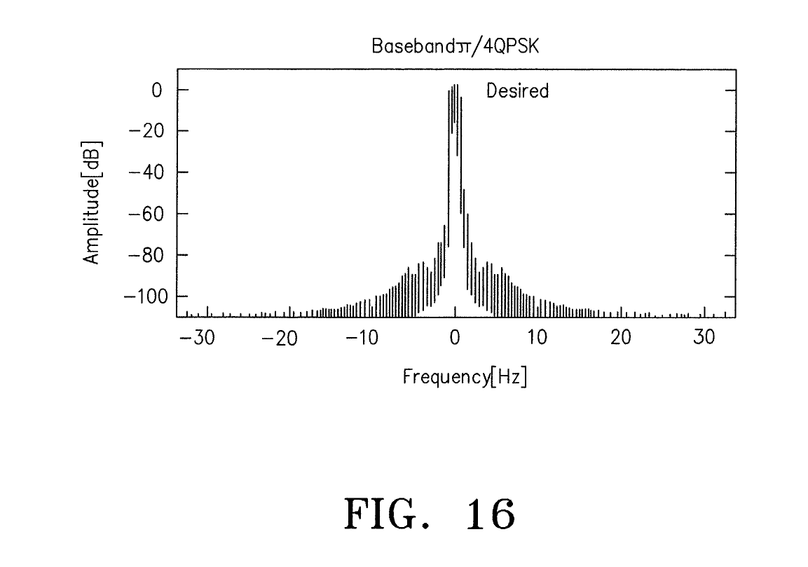

FIG. 17 illustrates a simulation result on the output characteristic of the first mixer in the transmitter illustrated in FIG. 15;

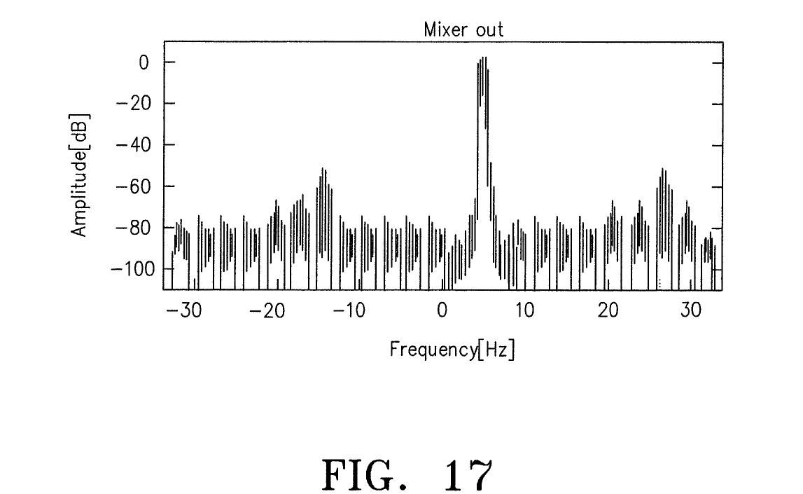

FIG. 18 illustrates a simulation result on the output characteristic of the DDS used for the first mixer in the transmitter illustrated in FIG. 15;

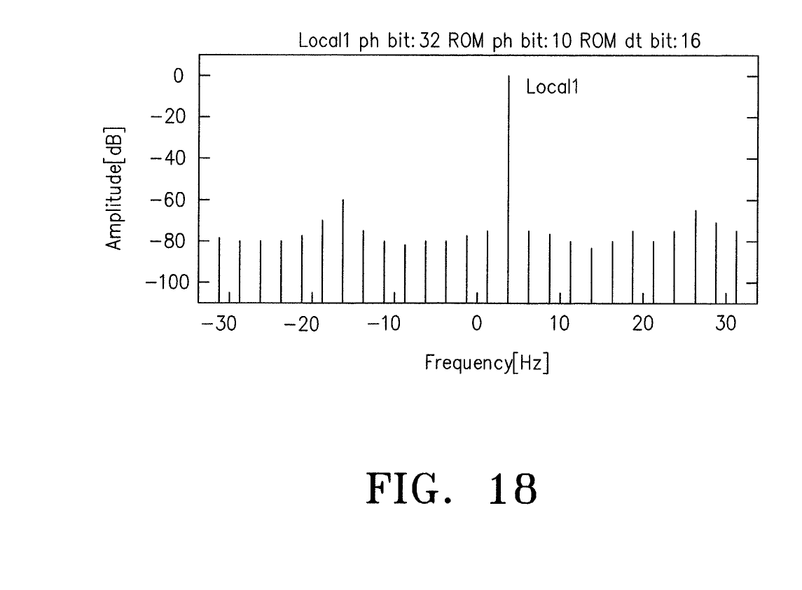

FIG. 19 illustrates a simulation result on the output characteristic of the PLL used for the second mixer in the transmitter illustrated in FIG. 15;

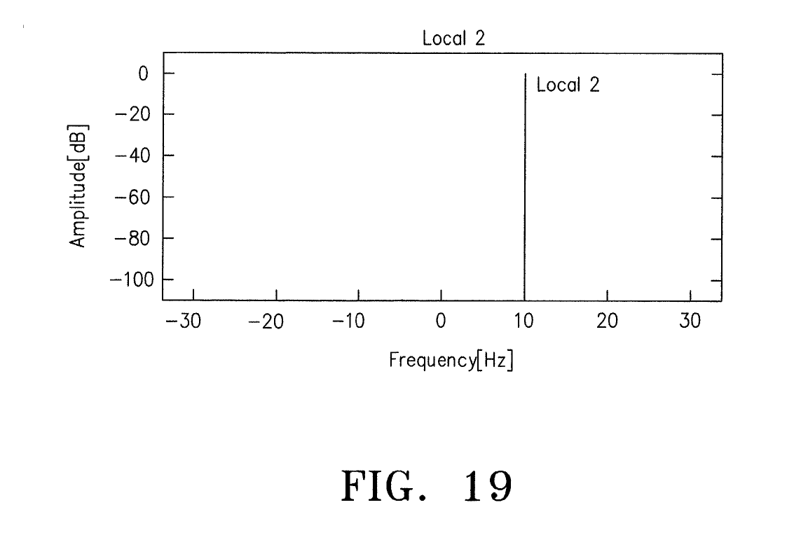

FIG. 20 illustrates a simulation result on the output characteristic of the transmitter illustrated in FIG. 15;

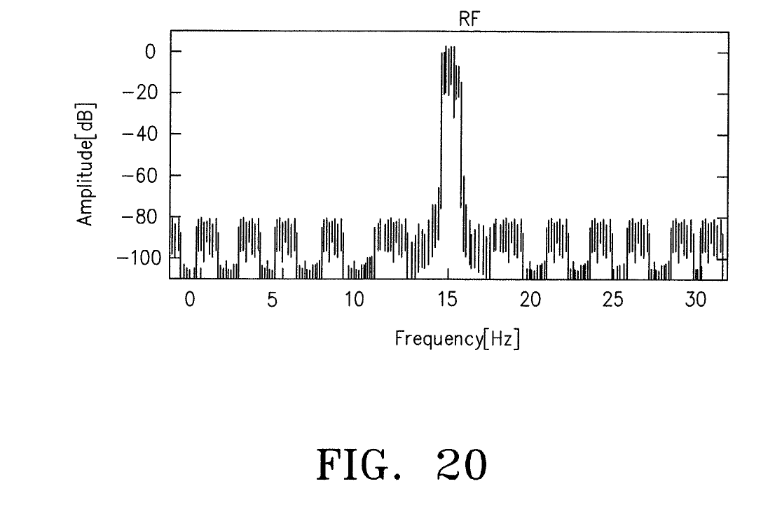

FIG. 21 illustrates a structure of another transmitter according the prior art;

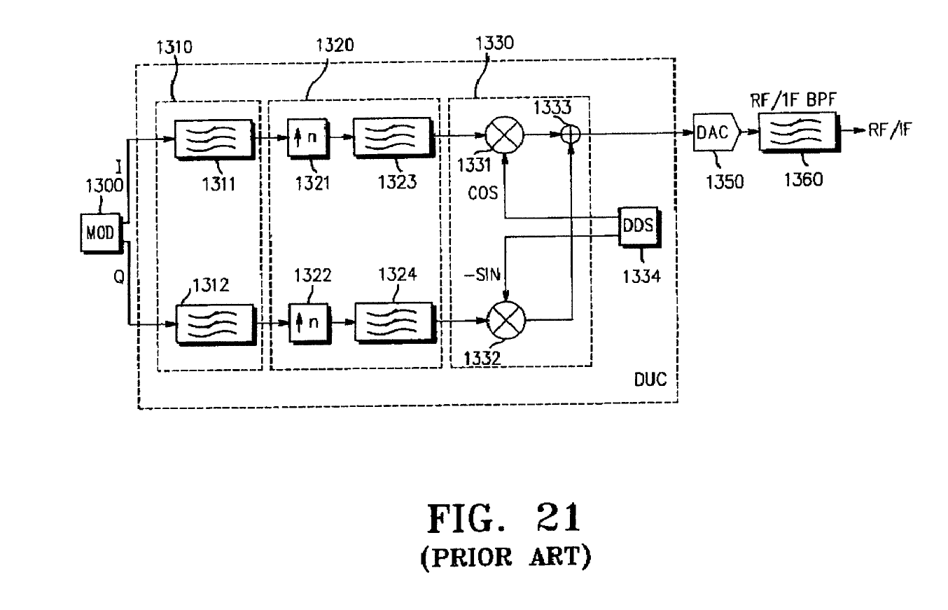

FIG. 22 illustrates a simulation result on the output characteristics of roll-off filters in the transmitter illustrated in FIG. 21;

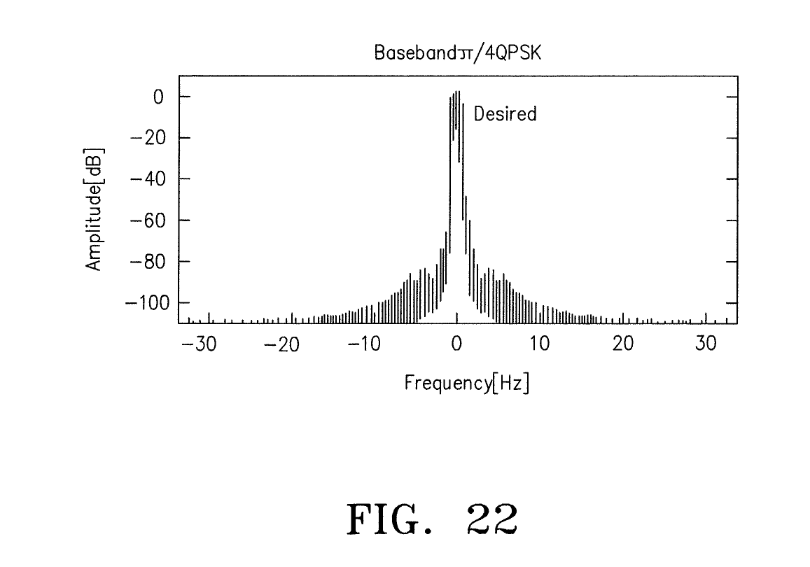

FIG. 23 illustrates a simulation result on the output characteristic of the DDS used for the mixer in the transmitter illustrated in FIG. 21; and

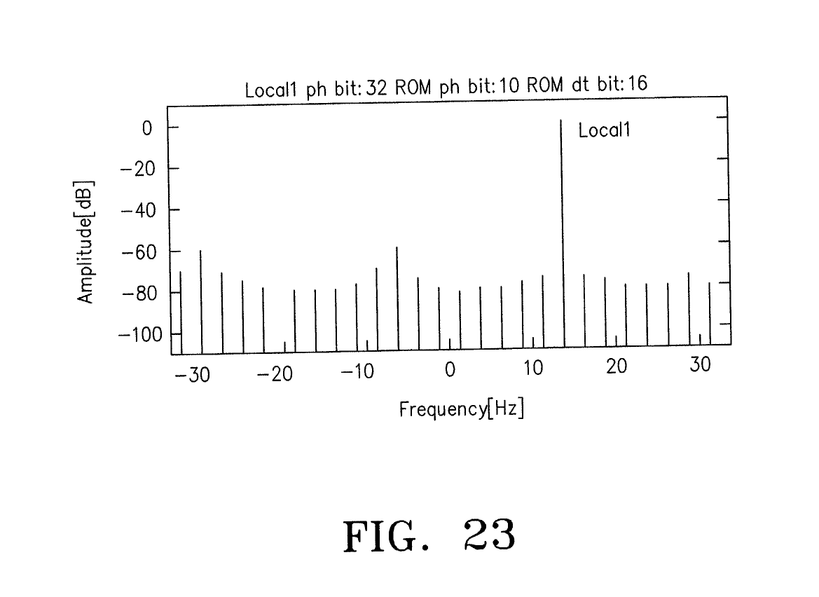

FIG. 24 illustrates a simulation result on the output characteristic of the transmitter illustrated in FIG. 21.

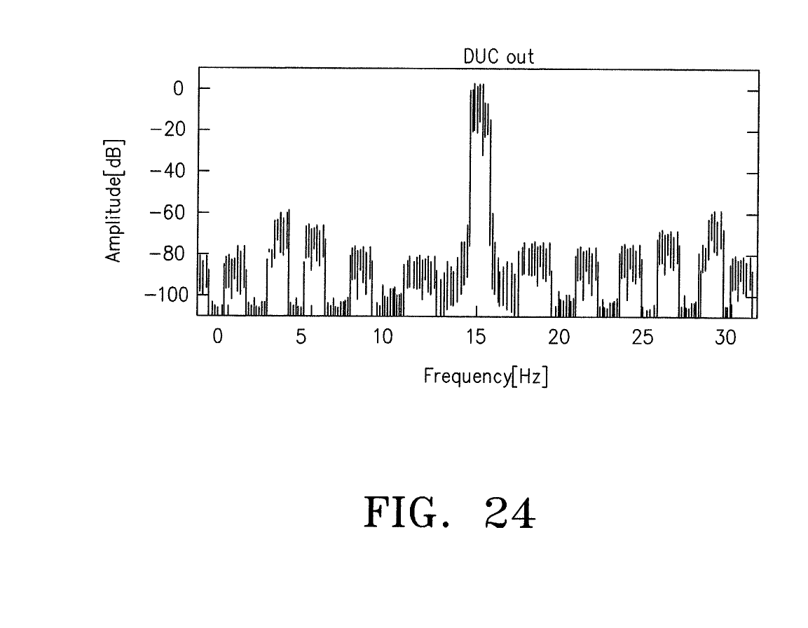

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

Embodiment #1

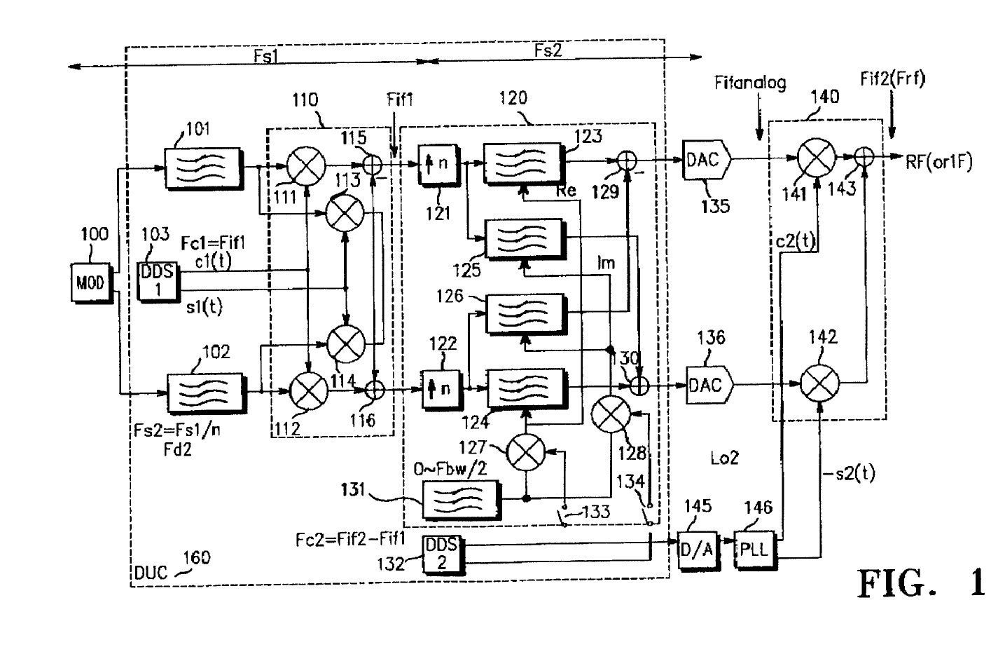

FIG. 1 illustrates a structure of a transmitter according to a first embodiment of the present invention. Referring to FIG. 1, a digital up-converter (DUC) 160 includes roll-off filters 101 and 102 receiving output signals of a modulator 100, which quadrature-modulates input digital data and outputs a baseband signal comprised of an in-phase component signal I and a quadrature-phase component signal Q; a first mixer 110 for converting a frequency of output signals of the roll-off filters 101 and 102 to a first IF frequency Fif1; and an interpolation bandpass filter (BPF) 120 for performing band limitation to remove out-band signals from the outputs of the first mixer 110. The interpolation bandpass filter 120 is comprised of a digital filter.

Further, the transmitter includes DACs 135 and 136 for subjecting the outputs of the interpolation bandpass filter 120 to digital-to-analog conversion; a second mixer 140 for converting the output signals of the DACs 135 and 136 to an RF signal or IF signal having a desired output frequency of Frf (or Fif2); a first DDS 103 serving as a reference signal generator of a local signal generator constituting the first mixer 110; and a second DDS 132 serving as a reference signal generator of a local signal generator constituting the second mixer 140.

The first mixer 110 is comprised of multipliers 111-114, a subtracter 115, and an adder 116. Although the subtracter 115 is implemented with an adder, the adder performs subtraction in practice. Thus, in the following description, the adder implementing the subtracter 115 will be called a “subtracter”.

The interpolation bandpass filter 120 is comprised of up-samplers 121 and 122; bandpass filters 123-126 each implemented with a complex coefficient-complex FIR filter whose passband Fb2 is equal to a channel bandwidth Fbw; multipliers 127 and 128; an adder 130; a subtracter 129; and a reference lowpass filter (LPF) 131 with a passband of 0 to Fbw/2.

The second mixer 140 is comprised of multipliers 141 and 142, and an adder 143 for adding outputs of the multipliers 141 and 142. The second mixer 140 is connected to a D/A converter 145 for D/A-converting the output of the second DDS 132, and a PLL 146 for providing the multipliers 141 and 142 with local oscillation signals having a 90° phase offset by inserting an output signal of the D/A converter 145.

Further, the transmitter includes switches 133 and 134 for providing the output of the second DDS 132 to the multipliers 127 and 128 during initialization.

If it is assumed that an oscillation frequency Fc1 by the first DDS 103 is Fif1, and an oscillation frequency Fc2 by the second DDS 132 is Fif2 (or Frf) at the output of the second mixer 140, then Fc2=Fif2−Fif1.

Filter coefficients of the bandpass filters 123-126 constituting the interpolation bandpass filter 120 are initialized when the digital up-converter initiates an operation. The initialization is performed by temporarily turning ON the switches 133 and 134. That is, when the switches 133 and 134 are turned ON, complex signals c2(t) and −s2(t) output from the second DDS 132 are provided to the multipliers 127 and 128, respectively, and then multiplied by a filter coefficient (real coefficient) set by the reference lowpass filter 131. The output of the multiplier 127 is provided to the bandpass filters 123 and 124. The output of the multiplier 128 is provided to the bandpass filters 125 and 126. After filter coefficients are provided to the bandpass filters 123-126, the switches 133 and 134 are turned OFF.

An operation of the above-described transmitter will be described in detail herein below. The in-phase component signal I and the quadrature-phase component signal Q of the quadrature-modulated signal output from the modulator 100 are subject to band limitation by the roll-off filters 101 and 102 to remove inter-code interference, and then provided to the first mixer 110. The first mixer 110 supporting complex mixing, is provided with local signals c1(t) and s1(t) with a frequency Fif1 from the first DDS 103 serving as a local signal generator. An output signal of the roll-off filter 101 is applied to the multipliers 111 and 113, where the applied signal is multiplied by the local signals c1(t) and s1(t), respectively. An output signal of the roll-off filter 102 is applied to the multipliers 112 and 114, where the applied signal is multiplied by the local signals c1(t) and s1(t), respectively. The output of the multiplier 112 is added to the output of the multiplier 113 by the adder 116, and the output of the multiplier 114 is subtracted from the output of the multiplier 111 by the subtracter 115, resulting in frequency conversion to the first IF frequency Fif1.

The output of the multiplier 111 is added to the output of the multiplier 114 by the adder 115, thus resulting in frequency conversion to a first IF signal (real part) with the frequency Fif1. Here, the adder 115 is provided with the output of the multiplier 111 at one input node and an inversed output of the multiplier 114 at another input node. Therefore, the adder 115 functions as a subtracter.

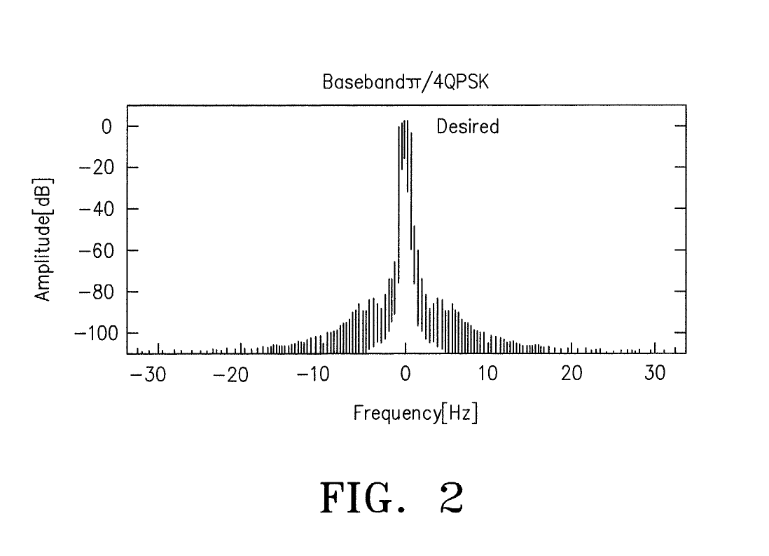

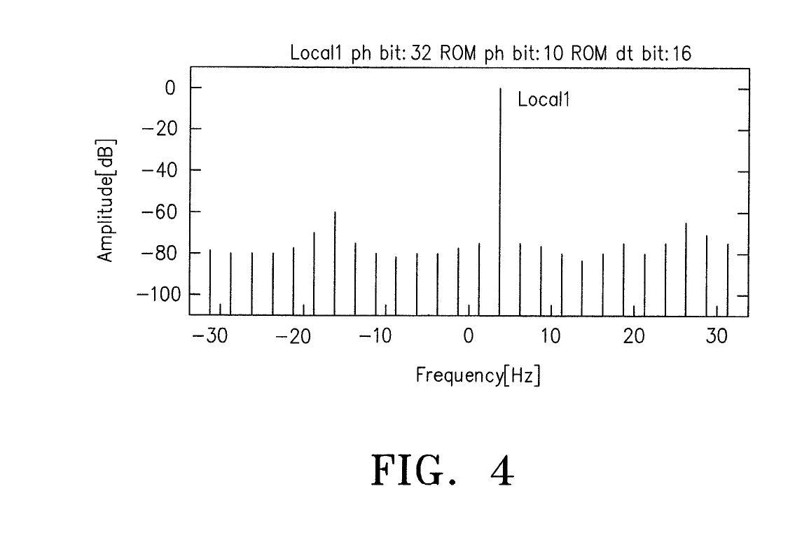

The output of the multiplier 112 is added to the output of the multiplier 113 by the adder 116, resulting in frequency conversion to a first IF signal (imaginary part) with the frequency Fif1. The digital up-converter was simulated in a state where the sampling frequencies are Fs1=Fs2=64 Hz, interpolation is n=1, the first DDS 103 has parameters of j=32, k=10 and m=16, and the second DDS 132 has parameters of j=k=5 and m=16. In this case, FIG. 2 illustrates an output of the roll-off filters, and FIG. 4 illustrates a spurious signal output from the first DDS 103 used for the first mixer 110.

Here, the frequency Fif1 becomes Fif1′ including an error frequency that cannot be converted by the second DDS 132 from the Fif1 to the output frequency Fif2 of the transmitter, so Fif1′=Fif1+(Fif2 mod (a frequency step of the second DDS 132)). When Fif1=5 Hz in the transmitter according to the embodiment, the frequency step of the second DDS 132 is 2 Hz. Thus, Fc2=10 Hz and Fif1=5.02 Hz. As a result, the frequency set by the first DDS 103 becomes Fc1=5.019999 . . . Hz.

Next, the output signals of the adders 115 and 116 are applied to the interpolation bandpass filter 120, in which the up-samplers 121 and 122 up-sample the received signals for sampling frequency conversion. Thereafter, the bandpass filters 123-126 having a bandpass filter characteristic with a passband Fbw band-limit the out-band signal including the spurious signal among the sampling frequency-converted signals. The spurious and aliasing-suppressed signals are provided to the second mixer 140 through the DACs 135 and 136.

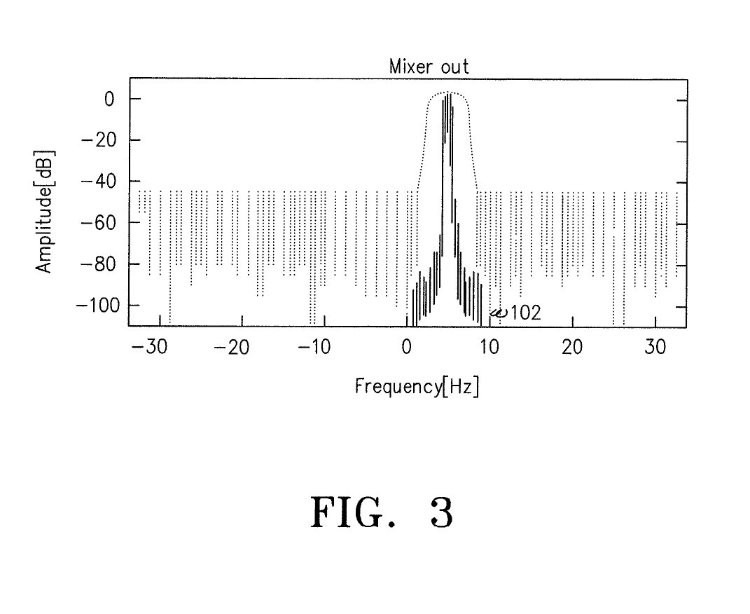

When the channel bandwidth is Fbw as stated above, filter coefficients of the bandpass filters (complex BPFs) 123-126 are calculated by multiplying a coefficient of the reference LPF 131, a reference real coefficient of the pass bandwidth Fbw/2 during an initial operation of the digital up-converter, by the outputs of the second DDS 132 by the multipliers 127 and 128. There is no sampling frequency conversion by the up-samplers 121 and 122 with n=1. When the simulation is performed in an ideal condition, where frequency shift from the reference LPF 131 is performed without using the DDS, the characteristic of the complex BPFs and the output spectrum of the complex BPFs are illustrated in FIG. 3. It is apparent from FIG. 3 that the spurious signal is suppressed below −100 dBc using the BPF with a stop band attenuation 40 dB.

The multipliers 141 and 142 in the second mixer 140 multiply the output signals of the DACs 135 and 136 by local signals c2(t) and −s2(t), respectively. The local signals c2(t) and −s2(t) are obtained by converting the output signal of the second DDS 132 by means of the D/A converter 145 and then processing the converted signal by means of the PLL 146 that receives the converted signal as a reference signal. The local signals c2(t) and −s2(t) with a frequency Fc2 have a 90° phase offset. The multiplied results of the multipliers 141 and 142 are added to each other by the adder 143, resulting in frequency conversion to a second IF signal or RF signal with a desired frequency Fif2 (or Frf).

Herein, the frequency Fc2 of the local signals output from the second DDS 132 is Fc2=Fif2−Fif1.

The present invention has been devised to rough (for example, roughing the frequency step of the second DDS 132 means that it reduces the operation word length j of the phase data operator comprised of the adder 200 and the phase register 201) a frequency step of the local signal generator used in the mixer for RF-converting the output of the DUC while minimizing the output spurious signal of the DUC in the transmitter, thereby improving the entire performance of the transmitter and reducing power consumption and the cost.

In the invention, the output signals of the modulator 100 are subject to frequency conversion to the first IF signal by the first mixer 110. Here, although the frequency step in the first DDS 103 serving as a first local signal generator, used for the first mixer 110, is subdivided, there are many spurious signals. Therefore, the first IF signal includes many spurious signals. After out-band spurious signals are suppressed by the interpolation bandpass filter 120, the frequency step becomes rough. However, the first IF signal is subject to frequency conversion to a desired frequency by the second mixer 140 using the second DDS 132 as a second local signal generator.

The second local signal generator providing the second mixer 140 with the local oscillation signals includes the PLL 146 operating based on the output signal of the second DDS 132 serving as a signal generator by digital signal processing. The PLL 146 multiplies a reference signal determined by D/A-converting the output of the second DDS 132 by M/N (where M and N are both integer). For the local signal generator providing the first mixer 110 with the local oscillation signal and the local signal generator providing the second mixer 140 with the local oscillation signal, a DDS where a relation between the operation accuracy and the spurious signal is precisely analyzed is used. For example, a local signal generator, called a DDS-driven PLL, for multiplying the output of the DDS by M/N, is used for the second local signal generator.

In the case where the sampling frequency (or operating frequency) of the second DDS 132 is higher than the sampling frequency of the first DDS 103 by interpolation processing before the second mixer 140 and equal to two times the sampling frequency of the first DDS 103, if the ROM size of the second DDS 132 is a half of the ROM size of the first DDS 103, power consumption by the ROM in the first DDS 103 is equal to that by the ROM in the second DDS 132. Otherwise, if the ROM size of the second DDS 132 is ¼ times the ROM size of the first DDS 103, the power consumption by the ROM in the first DDS 103 is less than that by the ROM in the second DDS 132.

However, there is power consumption by elements other than the ROM in the DDS. When the power consumption by the elements other than the ROM is equal to the power consumption by the ROM, the power consumption by the elements other than the ROM in the first DDS 103 increases with the sampling frequency. Therefore, when an operation word length of the first DDS 103 is two times longer than an operation word length of the second DDS 132, although the sampling frequency of the second DDS 132 is double, the ROM size should be reduced to below ¼ in order that the power consumption of the first DDS 103 is less than the power consumption of the second DDS 132.

In addition, when the sampling frequency of the first DDS 103 is equal to the sampling frequency of the second DDS 132, if an operation word length of the first DDS 103 is shorter than an operation word length of the second DDS 132, the ROM size is decreased, resulting in a reduction in the power consumption.

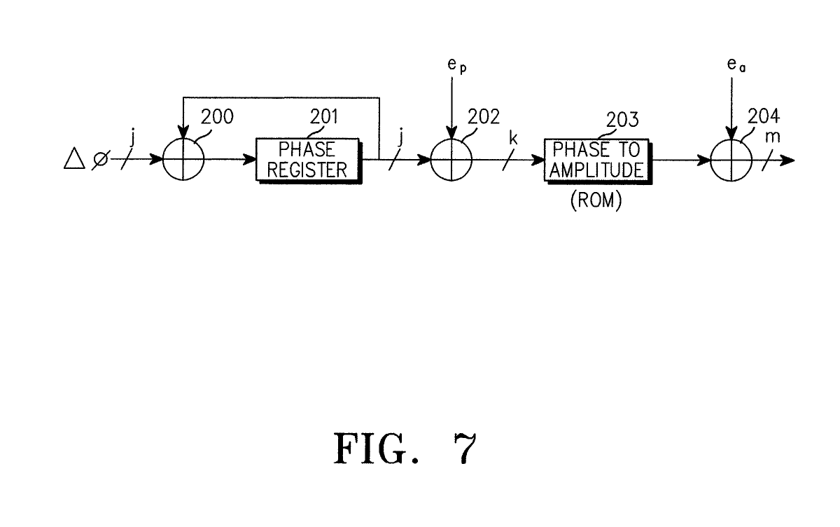

Roughing the frequency step of the second DDS 132 reduces an operation word length j of the phase data operator comprised of the adder 200 and the phase register 201 illustrated in FIG. 7.

Accordingly, when a bit length equal to an address length k of the ROM in the first DDS 103 with a subdivided frequency step is taken as an address length of the ROM in the second DDS 132, a difference between the operation word length j of the phase data operator and the address length k of the ROM 203 is reduced. Accordingly, if the phase error eₚ is less than the first DDS 103 with the subdivided frequency step, the spurious level caused by the phase error eₚ is lowered.

Therefore, even though the ROM sizes occupying a large portion of the entire power consumption by the DDS are equal to each other, it is possible to reduce the spurious level of the second DDS 132 with the rough frequency step. When a frequency step ratio of the first DDS 103 to the second DDS 132 is high, the j of the second DDS 132 is shorter than the k of the first DDS 103. Even though j=k for the second DDS 132, the ROM size of the second DDS 132 is less than the ROM size of the first DDS 103, so the power consumption by the second DDS 132 is less than the power consumption by the first DDS 103. Also, the second DDS 132 has a lower spurious level (i.e., the spurious signal caused by the phase error is not generated).

In addition, the spurious signal in the first mixer 110 caused by the spurious signal of the first DDS 103 is suppressed by the interpolation bandpass filter 120 connected to the first mixer 110. Therefore, it is not necessary to maintain the spurious level of the DDS in a level where it does not interfere to the adjacent frequency. Because of this, it is possible to reduce the address length k and the output bit length m of the ROM related to the spurious level, thus contributing to a reduction in the ROM size and the power consumption by the DDS.

Therefore, the first DDS 103 and the second DDS 132 in the digital up-converter 160 of the transmitter according to the embodiment of the present invention is smaller in size than the DDSs in the conventional transmitter. As a result, when the power consumption by the DDS takes a large portion of the entire power consumption by the transmitter, it is possible to remarkably reduce the power consumption.

Furthermore, the sampling rate of the DDS is restricted by a reduction in a processing speed of the phase operator (adder) due to an increase in the operation word length j in the phase data operator, and a reduction in a processing speed due to a decrease in an access speed of the ROM caused by an increase in the address length k of the ROM for converting phase data to amplitude data.

In the second DDS 132, it is possible to reduce the operation word length of the phase operator and the address length k of the ROM for converting the phase data to the amplitude data, thus contributing to an increase in the sampling rate and an increase in an output sampling frequency of the second DDS 132. If the sampling frequency of the second DDS 132 is high, the output frequency can also be set high. Thus, it is possible to improve a response characteristic of the PLL 146 by decreasing an M/N value of the PLL 146 that has a large M/N value due to the low DDS frequency.

In addition, it is possible to obtain a DDS capable of preventing generation of the spurious signal in the second mixer 140 and generation of the spurious signal caused by the phase error eₚ, by making the phase operation word length j of the second DDS 132 be equal to the address length (input word length) k of the ROM for converting the phase data to the sine/cosine waves.

The PLL-driven DDS suppresses the DDS spurious signal generated at the outside of a band of a PLL loop filter by virtue of the PLL operation. However, suppressing the DDS spurious signal even around the carrier decreases the loop filter band, resulting in an increase in a response time of the PLL. However, it is possible to design a PLL regardless of suppressing the spurious signal of the DDS by suppressing the spurious signal of the DDS itself.

Further, since the DDS constituting the second local signal generator can have a rough frequency step, a table look-up scheme (table reading scheme) for generating a signal by simply reading sine/cosine wave data can be used. In this case, it is possible to vary a frequency to some extent by varying a length of the look-up table. In this case, by writing a plurality of periods in the table, it is possible to make an output frequency of the look-up table become fs×n/m, where fs is a sampling frequency, m is a table length and n is a repetition frequency in the table.

In the first embodiment of the present invention, it is possible to reduce the power consumption of the first mixer 110 by performing sampling frequency conversion between the first mixer 110 and the second mixer 140, and decreasing the sampling frequency of the first mixer 110.

The first mixer 110 of the digital up-converter 160 according to the embodiment of the present invention is not required to convert the frequency to a great extent, so it can decrease the sampling frequency. The first mixer 110 converts the sampling frequency to a higher frequency by performing frequency conversion to a relatively low frequency in a step subdivided by the low sampling frequency, and the second mixer 140 performs frequency conversion to a target frequency using the second DDS 132 serving as the second local signal generator with a low spurious level.

As described above, the first embodiment of the present invention suppresses an increase in the power consumption by performing sampling frequency conversion between the first mixer 110 and the second mixer 140, although the number of mixers is increased by one as compared with the conventional digital up-converter.

Further, it is possible to reduce the power consumption of the local signal generator used by the second mixer as compared with the power consumption of the conventional local signal generator. Therefore, the digital up-converter according to the first embodiment of the present invention having the reduced power consumption of the first mixer and the local signal generator due to the low sampling frequency remarkably reduces the power consumption as compared with the conventional digital up-converter.

When the local signal generator is implemented with the DDS, the operation word length j of the phase operator in the first DDS 103 is reduced in proportion to the sampling frequency (strictly speaking, in proportion to 2^{j}) due to the decrease in the sampling frequency of the first mixer 110. When the sampling frequency is reduced to ¼, the frequency step is equal to that used when the sampling frequency is not reduced, although the j is reduced by log₂(¼)=2 bits. When the spurious level is equal, a reduction in the operation word length j decreases the address length k of the ROM by 2 bits and also remarkably reduces the circuit scale and the power consumption. It is also possible to ease the spurious suppression characteristic required by the interpolation bandpass filter 120 connected to an output node of the first mixer 110, by decreasing the spurious level rather than reducing the address length k of the ROM. Even in this case, it is possible to reduce the power consumption by reducing, if possible, the circuit scale of the interpolation bandpass filter 120.

In addition, it is possible to decrease the number of the filters from 2 to 1, by using the bandpass filter connected to the output node of the first mixer 110, i.e., the interpolation bandpass filter 120 both as the interpolation filter and the spurious suppression filter.

It is possible to vary a passband frequency of the interpolation bandpass filter 120 by calculating a filter coefficient of the interpolation bandpass filter 120 for passing the first IF signal converted by the first mixer 110 by a frequency shifting technique of the reference LPF 131.

The bandwidth of the reference LPF 131 for the real coefficient is Fbw/2, where Fbw denotes a channel bandwidth. When a coefficient of the reference LPF 131 is multiplied by e^{j(nω)}, the band of the reference LPF 131 is shifted by ω on the complex frequency. That is, a complex BPF with a channel bandwidth Fbw is created. When the coefficient of the reference LPF 131 is multiplied by cos(nω), the characteristic is shifted in the positive/negative direction, so a passband is generated even in the imaginary frequency (complex conjugate frequency). However, operations (or circuit scale) of the reference LPF 131 are halved as compared with the complex BPF, contributing to a reduction in power consumption.

Further, the reference LPF 131 may be replaced with a reference BPF with a bandwidth Fbw rather than the LPF. Of course, it is also possible to calculate a filter with a desired characteristic and store required filter data for a channel in a ROM. Since the ROM is different from the ROM in the DDS, which is accessed in real time, it does not affect the power consumption.

When the stop band characteristic is not strict, if frequency shifting is performed by a frequency synthesizer with a poor spurious characteristic, the characteristic of a filter calculated by the frequency shifting technique is deteriorated. However, it is possible to prevent deterioration of the filter characteristic shifted by setting the filter coefficient by the first DDS 103 serving as the first local signal generator in the digital up-converter when the digital up-converter starts operation.

If the mixer uses a local signal generator with a poor spurious characteristic, its output signal has a deteriorated spurious characteristic. That is, the use of the signal generator with a poor spurious characteristic for the frequency shift deteriorates the filter characteristic after frequency shifting.

The stop band characteristic is important in the filter characteristic calculated by the frequency shifting technique, and the passband of the filter is allowed to become wide to some extent. Further, when a shift band characteristic is also not strict, it is possible to set the filter coefficient at the timing when the digital up-converter starts operation, by the second DDS 132 constituting the second local signal generator in the digital up-converter.

Further, in the first embodiment of the present invention, it is possible to prevent C/N deterioration of the second local signal generator caused by C/N of the sampling clock, by utilizing an output of a crystal signal generator as the sampling clock used in the second DDS 132. In addition, since the digital signal processor does not require a high C/N, only the D/A converter may use the sampling clock output from the crystal signal generator.

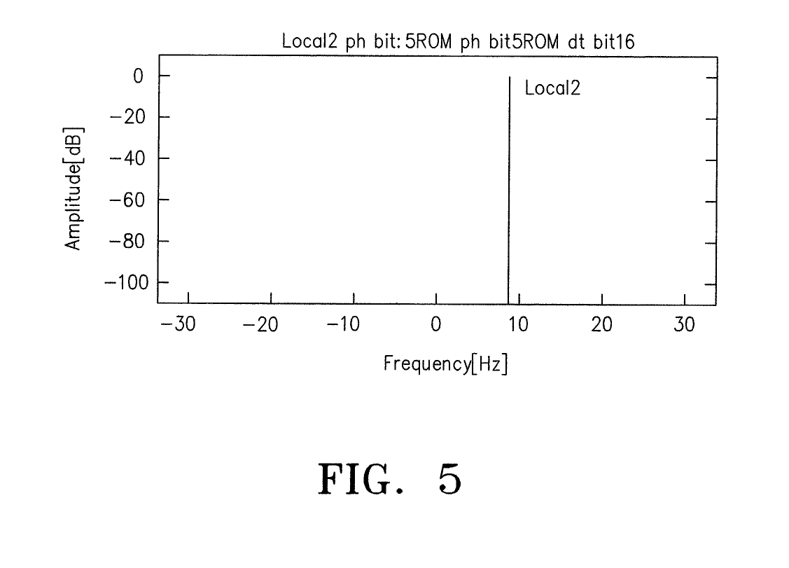

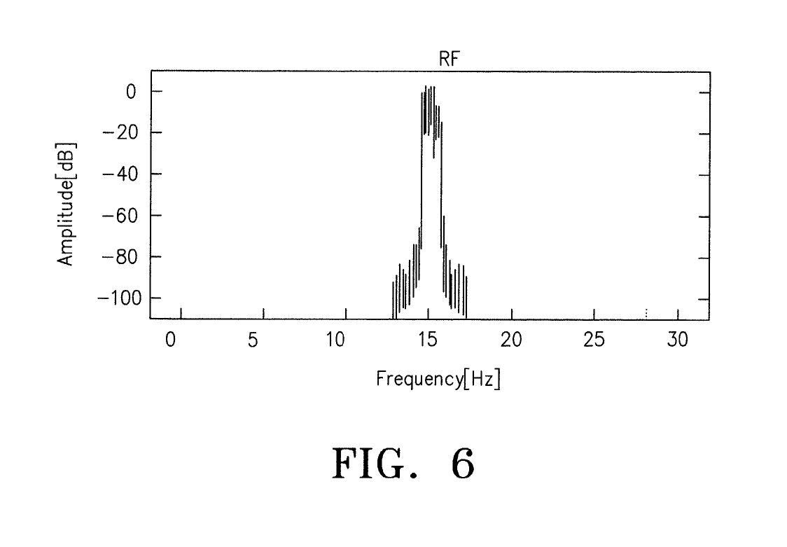

The output of the complex BPF (interpolation BPF) is subjected to frequency conversion to a target frequency and conversion to a real signal by the second mixer 140, and then output as an RF or IF signal by the D/A converter. According to the simulation, since the spurious level of the second DDS 132 illustrated in FIG. 5 is below −100 dBc, the output of the digital up-converter illustrated in FIG. 6 has a considerably excellent spurious characteristic. Here, the spurious characteristic is a characteristic obtained by frequency shifting the first IF signal.

The simulation results of the transmitter according to the present invention, illustrated in FIGS. 2 to 6, are obtained when sampling frequencies are Fs1=Fs2=64 Hz; the first DDS 103 has a phase operation word length of 32 bits, a ROM size of 1 K words, a ROM output bit length of 16 bits, and interpolation of n=1; the second DDS 132 has a phase operation word length of 5 bits, a ROM size of 32 words, a ROM output bit length of 16 bits; the PLL is not used; and the transmission frequency is 15.02 Hz. The spurious signal is suppressed below −100 dBc using the interpolation BPF 120 with a stop band attenuation 40 dB.

The output of the interpolation bandpass filter (complex BPF) 120 is converted to an analog IF signal with a frequency Fifanalog by the D/A converters 135 and 136, and then is subject to frequency conversion to a target RF frequency and conversion to a real signal by the second mixer 140. According to the simulation results, since the spurious level of the second DDS 132 illustrated in FIG. 5 is below −100 dBc, the output of the digital up-converter illustrated in FIG. 6 has a considerably excellent spurious characteristic. Here, the spurious characteristic is a characteristic obtained by frequency shifting the first IF signal.

In the first embodiment of the present invention, the digital signal processor, i.e., the digital up-converter (DUC) has a single-stage mixer, for simplicity. However, in order to prevent an increase in the power consumption due to an increase in the operation frequency of the filter for removing the spurious signal of the DDS, it is also possible to decrease the first IF frequency output from the first mixer, suppress the spurious signal by a spurious suppressing filter without performing sampling frequency conversion at the output stage of the first mixer, provide another mixer stage before outputting the filter output to the D/A converter, and subject the output of the added mixer to sampling frequency conversion by the interpolation filter. Since the DDS used as a local signal generator can have a frequency step (including the frequency subdivided by the first local signal generator), a DDS with a low spurious level can be used, when the ROM size is decreased.

Further, in the first embodiment of the present invention, the first mixer is a complex mixer, and the output of the mixer is bandpass filtered by the complex coefficient filters. However, since the mixer and the bandpass filters reduce the circuit scale and power consumption, they can be replaced with a real output mixer and real coefficient filters.

In the first embodiment, the reference LPF 131 has the same characteristic as the roll-off filters. It is possible to make the roll-off filters 101 and 102 unnecessary by utilizing a frequency synthesizer capable of setting a frequency step for frequency shifting of the filter coefficient. Here, the set frequency step is a frequency step subdivided by the first DDS 103 rather than the second DDS 132.

In addition, unless the spurious characteristic of the first DDS 103 deteriorates the stop band characteristic of the interpolation bandpass filter 120 below a permissible level, it is possible to perform frequency shifting using the first DDS 103.

Embodiment #2

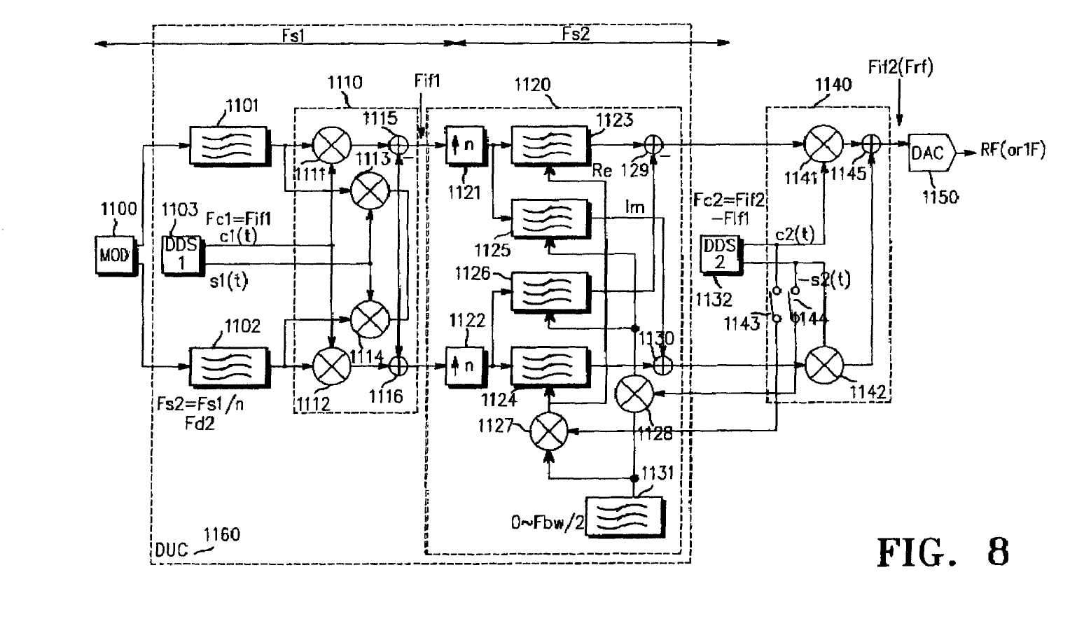

FIG. 8 illustrates a structure of a digital up-converter according to a second embodiment of the present invention. Referring to FIG. 8, a digital up-converter (DUC) 1160 includes roll-off filters 1101 and 1102 receiving output signals of a modulator 1100, which quadrature-modulates input digital data and outputs a baseband signal comprised of an in-phase component signal I and a quadrature-phase component signal Q; a first mixer 1110 for converting a frequency of output signals of the roll-off filters 1101 and 1102 to a first IF frequency Fif1; and an interpolation bandpass filter (BPF) 1120 for performing band limitation to remove out-band signals from the outputs of the first mixer 1110. The interpolation bandpass filter 1120 is comprised of a digital filter.

Further, the digital-up converter 1160 includes a second mixer 1140 for converting the output signals of the interpolation BPF 1120 to an output frequency provided to a D/A converter (DAC) 1150; a first DDS 1103 serving as a local signal generator of the first mixer 1110; and a second DDS 1132 serving as a local signal generator of the second mixer 1140.

The first mixer 1110 is comprised of multipliers 1111-1114, a subtracter 1115, and an adder 1116. Although the subtracter 1115 is implemented with an adder, the adder performs subtraction in practice. Thus, in the following description, the adder implementing the subtracter 1115 will be called a “subtracter”.

The interpolation bandpass filter 1120 is comprised of up-samplers 1121 and 1122; bandpass filters 1123-1126 each implemented with a complex coefficient-complex FIR filter whose passband Fb2 is equal to a channel bandwidth Fbw; multipliers 1127 and 1128; an adder 1130; a subtracter 1129; and a reference lowpass filter (LPF) 1131 with a passband of 0 to Fbw/2.

The second mixer 1140 is comprised of multipliers 1141 and 1142; switches 1143 and 1144 for providing the output of the second DDS 1132 to the multipliers 1127 and 1128 during initialization; and an adder 1145 for adding outputs of the multipliers 1141 and 1142.

If it is assumed that an oscillation frequency Fc1 of the first DDS 1103 is Fif1, and an oscillation frequency Fc2 of the second DDS 1132 is Fif2 at the output of the second mixer 1140, then Fc2=Fif2−Fif1.

Filter coefficients of the bandpass filters 1123-1126 constituting the interpolation bandpass filter 1120 are initialized when the digital up-converter 1160 initiates an operation. The initialization is performed by temporarily turning ON the switches 1143 and 1144. That is, when the switches 1133 and 1134 are turned ON, complex signals c2(t) and −s2(t) output from the second DDS 1132 are provided to the multipliers 1127 and 1128, respectively, and then multiplied by a filter coefficient (real coefficient) set by the reference lowpass filter 1131. The output of the multiplier 1127 is provided to the bandpass filters 1123 and 1124. The output of the multiplier 1128 is provided to the bandpass filters 1125 and 1126. After filter coefficients are provided to the bandpass filters 1123-1126, the switches 1133 and 1134 are turned OFF.

An operation of the above-described digital up-converter will be described in detail herein below. The in-phase component signal I and the quadrature-phase component signal Q of the quadrature-modulated signal output from the modulator 1100 are subject to band limitation by the roll-off filters 1101 and 1102 to remove inter-code interference, and then provided to the first mixer 1110. The first mixer 1110 supporting complex mixing, is provided with local signals c1(t) and s1(t) with a frequency Fif1 from the first DDS 1103 serving as a local signal generator. An output signal of the roll-off filter 1101 is applied to the multipliers 1111 and 1113, where the applied signal is multiplied by the local signals c1(t) and s1(t), respectively. An output signal of the roll-off filter 1102 is applied to the multipliers 1112 and 1114, where the applied signal is multiplied by the local signals c1(t) and s1(t), respectively. The output of the multiplier 1112 is added to the output of the multiplier 1113 by the adder 1116, and the output of the multiplier 1114 is subtracted from the output of the multiplier 1111 by the subtracter 1115, resulting in frequency conversion to the first IF frequency Fif1.

The output of the multiplier 1111 is added to the output of the multiplier 1114 by the adder 1115, thus resulting in frequency conversion to a first IF signal (real part) with the frequency Fif1. Here, the adder 1115 is provided with the output of the multiplier 1111 at one input node and an inversed output of the multiplier 1114 at another input node. Therefore, the adder 1115 functions as a subtracter.

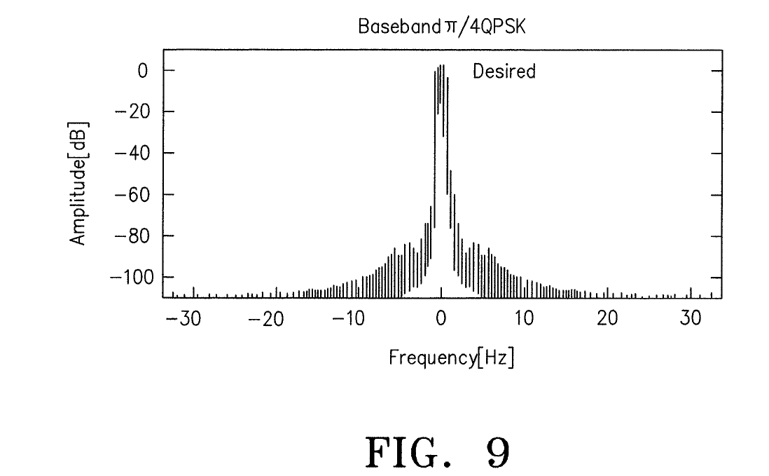

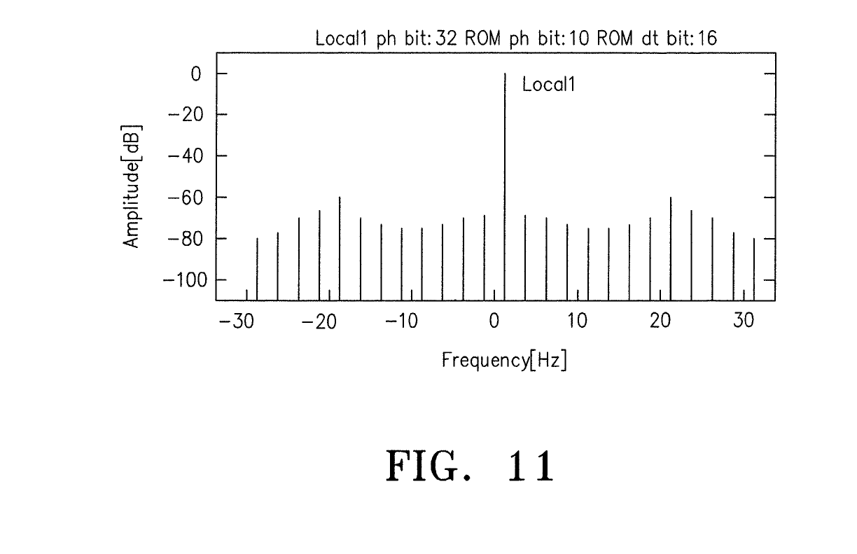

The output of the multiplier 1112 is added to the output of the multiplier 1113 by the adder 1116, resulting in frequency conversion to a first IF signal (imaginary part) with the frequency Fif1. The digital up-converter 1160 is simulated in a state where the sampling frequencies are Fs1=Fs2=64 Hz, interpolation is n=1, the first DDS 1103 has parameters of j=32, k=10 and m=16, and the second DDS 1132 has parameters of j=k=5 and m=16. In this case, FIG. 9 illustrates an output of the roll-off filters, and FIG. 11 illustrates a spurious signal output from the first DDS 1103 used for the first mixer 1110.

Here, the frequency Fif1 becomes Fif1′ including an error frequency that cannot be converted by the second DDS 1132 from the Fif1 to the output frequency Fif2 of the transmitter, so Fif1′=Fif1+(Fif2 mod (a frequency step of the second DDS 1132)). When Fif1=5 Hz in the transmitter according to the embodiment, the frequency step of the second DDS 1132 is 2 Hz. Thus, Fc2=14 Hz and Fif1=1.02 Hz. As a result, the frequency set by the first DDS 1103 becomes Fc1=1.019999 . . . Hz.

Next, the output signals of the adders 1115 and 1116 are applied to the interpolation bandpass filter 1120, in which the up-samplers 1121 and 1122 up-sample the received signals for sampling frequency conversion. Thereafter, the bandpass filters 1123-1126 having a bandpass filter characteristic with a passband Fbw band-limit the out-band signal including the spurious signal among the sampling frequency-converted signals. The spurious and aliasing-suppressed signals are provided to the second mixer 1140.

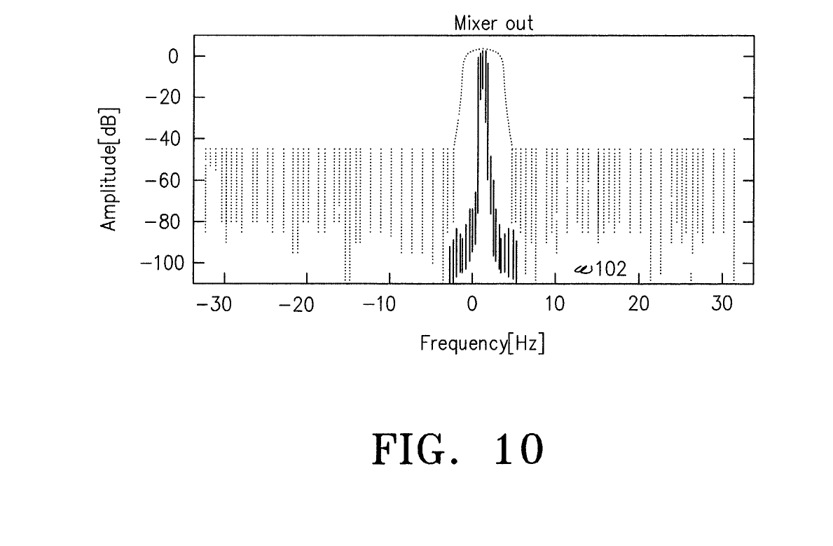

When the channel bandwidth is Fbw as stated above, filter coefficients of the bandpass filters (complex BPFs) 1123-1126 are calculated by multiplying a coefficient of the reference LPF 1131, a reference real coefficient of the pass bandwidth Fbw/2 during an initial operation of the digital up-converter 1160, by the outputs of the second DDS 1132 by the multipliers 1127 and 1128. There is no sampling frequency conversion by the up-samplers 1121 and 1122 with n=1. When the simulation is performed in an ideal condition where frequency shift from the reference LPF 1131 is performed without using the DDS, the characteristic of the complex BPFs and the output spectrum of the complex BPFs are illustrated in FIG. 10. It is apparent from FIG. 10 that the spurious signal is suppressed below −100 dBc using the BPF with a stop band attenuation 40 dB.

The multipliers 1141 and 1142 in the second mixer 1140 multiply the output signals of the interpolation bandpass filter 1120 by local signals c2(t) and −s2(t) with a frequency Fc2=Fif2−Fif1 output from the second DDS 1132, respectively. The multiplied results of the multipliers 1141 and 1142 are added to each other by the adder 1145, resulting in frequency conversion to a second IF signal or RF signal with a desired frequency Fif2. Herein, the frequency Fc2 of the local signals output from the second DDS 1132 is Fc2=Fif2−Fif1. The IF signal or RF signal with a frequency Fif2 output from the second mixer 1140 is converted to an analog IF signal or RF signal by the D/A converter 1150. In order to reduce operations, ploy-phase filters may be used for the complex coefficient-complex FIR filters 1123-1126.

The present invention is characterized by first performing frequency conversion to a relatively low frequency at the subdivided step and then performing frequency conversion to the target frequency, rather than converting when the baseband frequency or the low IF frequency signal is output from the modulator. The digital up-converter 1160 according to the present invention has lower power consumption than the conventional digital up-converter.

In the invention, the output signals of the modulator 1100 are subject to frequency conversion to the first IF signal by the first mixer 1110. Here, although the frequency step in the first DDS 1103 serving as a first local signal generator, used for the first mixer 1110, is subdivided, there are many spurious signals. Therefore, the first IF signal includes many spurious signals. After out-band spurious signals are suppressed by the interpolation bandpass filter 1120, the frequency step becomes rough. However, the first IF signal is subject to frequency conversion to a desired frequency by the second mixer 1140 using the second DDS 1132 as a second local signal generator with a low spurious level.

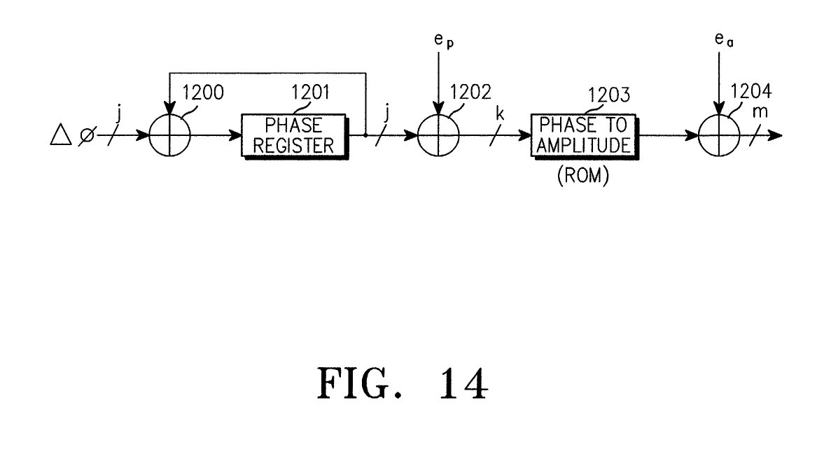

Roughing the frequency step of the second DDS 1132 reduces an operation word length j of the phase data operator comprised of the adder 1200 and the phase register 1201 illustrated in FIG. 14. Accordingly, when a bit length equal to an address length k of the ROM in the first DDS 1103 with a subdivided frequency step is taken as an address length of the ROM in the second DDS 1132, a difference between the operation word length j of the phase data operator and the address length k of the ROM 1203 is reduced. Accordingly, if the phase error eₚ is less than the first DDS 1103 with the subdivided frequency step, the spurious level caused by the phase error eₚ is lowered.

Therefore, even though the ROM sizes occupying a large portion of the entire power consumption by the DDS are equal to each other, it is possible to reduce the spurious level of the second DDS 1132 with the rough frequency step. When a frequency step ratio of the first DDS 1103 to the second DDS 1132 is high, the j of the second DDS 1132 is shorter than the k of the first DDS 1103. Even though j=k for the second DDS 1132, the ROM size of the second DDS 1132 is less than the ROM size of the first DDS 1103, so the power consumption by the second DDS 1132 is less than the power consumption by the first DDS 1103. Also, the second DDS 1132 has a lower spurious level (i.e., the spurious signal caused by the phase error is not generated).

In addition, the spurious signal in the first mixer 1110 caused by the spurious signal of the first DDS 1103 is suppressed by the interpolation bandpass filter 1120 connected to the first mixer 1110. Therefore, it is not necessary to maintain the spurious level of the DDS in a level where it does not interfere to the adjacent frequency, like in the prior art. Because of this, it is possible to reduce the address length k and the output bit length m of the ROM related to the spurious level, thus contributing to a reduction in the ROM size and the power consumption by the DDS.

Therefore, the first DDS 1103 and the second DDS 1132 in the digital up-converter of the transmitter according to the embodiment of the present invention can be smaller in size than the DDSs in the conventional transmitter. As a result, when the power consumption by the DDS takes a large portion of the entire power consumption by the digital up-converter, it is possible to remarkably reduce the power consumption.

Furthermore, the sampling rate of the DDS is restricted by a reduction in a processing speed of the phase operator (adder) due to an increase in the operation word length j in the phase data operator, and a reduction in a processing speed due to a decrease in an access speed of the ROM caused by an increase in the address length k of the ROM for converting phase data to amplitude data.

In the second DDS 1132, it is possible to reduce the operation word length j of the phase operator and the address length k of the ROM for converting the phase data to the amplitude data, thus contributing to an increase in the sampling rate and an increase in an output sampling frequency of the digital up-converter. Further, it is possible to simplify the analog circuit as the transmitter of the digital up-converter has a high processing speed, thus contributing to a reduction in the power consumption of the transmitter.

In addition, it is possible to obtain a DDS capable of preventing generation of the spurious signal in the second mixer 1140 and generation of the spurious signal caused by the phase error eₚ, by making the phase operation word length j of the second DDS 1132 be equal to the address length (input word length) k of the ROM for converting the phase data to the sine/cosine waves.

Further, since the DDS serving as the second local signal generator is allowed to have a rough frequency step, a table look-up scheme (table reading scheme) for generating a signal by simply reading sine/cosine wave data can be used. In this case, it is possible to vary a frequency to some extent by varying a length of the look-up table. In this case, by writing a plurality of periods in the table, it is possible to make an output frequency of the look-up table become fs×n/m, where fs is a sampling frequency, m is a table length and n is a repetition frequency in the table.

In the second embodiment of the present invention, it is possible to reduce the power consumption of the first mixer 1110 by performing sampling frequency conversion between the first mixer 1110 and the second mixer 1140.

The first mixer 1110 of the digital up-converter according to the second embodiment of the present invention is not required to convert the frequency to a great extent, so it can decrease the sampling frequency. The first mixer 1110 converts the sampling frequency to a higher frequency by performing frequency conversion to a relatively low frequency in a step subdivided by the low sampling frequency, and the second mixer 1140 performs frequency conversion to a target frequency using the second DDS 1132 serving as the second local signal generator with a low spurious level.

As described above, the embodiment of the present invention suppresses an increase in the power consumption by performing sampling frequency conversion between the first mixer 1110 and the second mixer 1140, although the number of mixers is increased by one as compared with the conventional digital up-converter. That is, since the sampling frequency of the first local signal generator is lower than the sampling frequency of the second local signal generator, it is possible to ignore an increase in the power consumption caused by existence of the two local signal generators.

When the local signal generator is implemented with the DDS, the operation word length j of the phase operator in the first DDS 1103 is reduced in proportion to the sampling frequency (strictly speaking, in proportion to 2^{j}) due to the decrease in the sampling frequency of the first mixer 1110. When the sampling frequency is reduced to ¼, the frequency step is equal to that used when the sampling frequency is not reduced, although the j is reduced by log₂(¼)=2 bits. Even in the case where the sampling frequency is not decreased, when the spurious level is equal, a reduction in the operation word length j decreases the address length k of the ROM by 2 bits and also remarkably reduces the circuit scale and the power consumption. It is also possible to ease the spurious suppression characteristic required by the interpolation bandpass filter 1120 connected to an output node of the first mixer 1110, by decreasing the spurious level through a reduction in the difference between the k and the j, rather than reducing the address length k of the ROM. Even in this case, it is possible to reduce the power consumption by reducing, if possible, the circuit scale of the interpolation bandpass filter 1120.

In addition, it is possible to decrease the number of the filters from 2 to 1, by using the bandpass filter connected to the output node of the first mixer 1110, i.e., the interpolation bandpass filter 1120 both as the interpolation filter and the spurious suppression filter.

A frequency of the IF signal converted by the first mixer 1110 deviates from the center IF frequency of the signal output from the first DDS 1103 serving as the first local signal generator, in order to correct a difference between the frequency that is set by the second mixer 1140 and the target frequency. The “deviation” becomes a maximum of ½ of the difference between the frequency that is set by the second mixer 1140 and the target frequency. Therefore, it is possible to fix a filter coefficient of the filter by adding ½ of the frequency step of the second DDS 1132 serving as the second local signal generator to the upper and lower frequencies over the filter passband of the IF signal.

It is possible to vary a passband frequency of the interpolation bandpass filter 1120 by calculating a filter coefficient of the interpolation bandpass filter 1120 for passing the first IF signal converted by the first mixer 1110 by a frequency shifting technique of the reference LPF 1131.

The bandwidth of the reference LPF 1131 is Fbw/2, where Fbw denotes a channel bandwidth. When a coefficient of the reference LPF 1131 is multiplied by e^{j(nω)}, the band of the reference LPF 1131 is shifted by ω on the complex frequency. That is, a complex BPF with a channel bandwidth Fbw is created. When the coefficient of the reference LPF 1131 is multiplied by cos(nω), the characteristic is shifted in the positive/negative direction, so a passband is generated even in the imaginary frequency (complex conjugate frequency). However, operations (or circuit scale) of the reference LPF 1131 are halved as compared with the complex BPF, contributing to a reduction in the power consumption.

Further, the reference LPF 1131 may be replaced with a reference BPF with a bandwidth Fbw rather than the LPF. Of course, it is also possible to calculate a filter with a desired characteristic and store required filter data for a channel in a ROM. Since the ROM is different from the ROM in the DDS, which is accessed in real time, it does not affect the power consumption.

When the stop band characteristic is not strict, if frequency shifting is performed by a frequency synthesizer with a poor spurious characteristic, the characteristic of a filter calculated by the frequency shifting technique is deteriorated. However, it is possible to prevent deterioration of the filter characteristic shifted by setting the filter coefficient by the first DDS 1103 serving as the first local signal generator in the digital up-converter 1160 when the digital up-converter 1160 starts operation.

If the mixer uses a local signal generator with a poor spurious characteristic, its output signal has a deteriorated spurious characteristic. That is, the use of the signal generator with a poor spurious characteristic for the frequency shift deteriorates the filter characteristic after frequency shifting.

The stop band characteristic is important in the filter characteristic calculated by the frequency shifting technique, and the passband of the filter can become wide to some extent. The passband may deviate from the signal band. Further, when a shift band characteristic is also not strict, it is possible to set the filter coefficient at the timing when the digital up-converter 1160 starts operation, by the second DDS 1132 constituting the second local signal generator in the digital up-converter 1160.

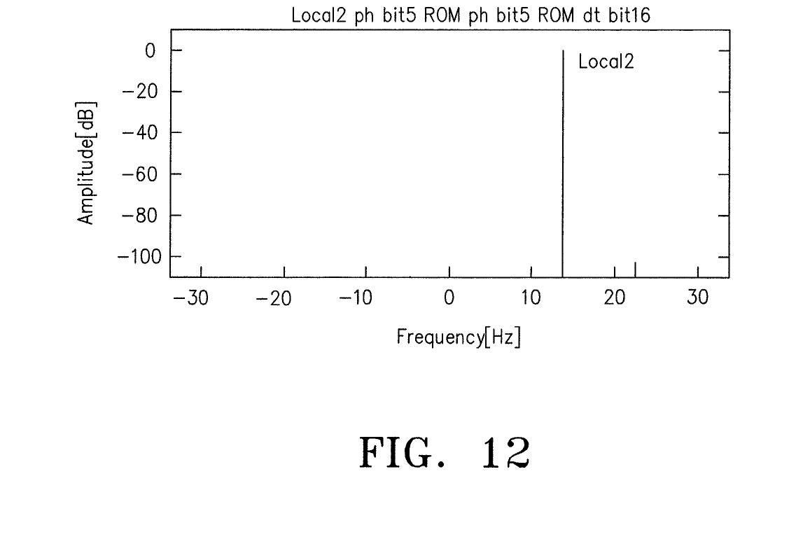

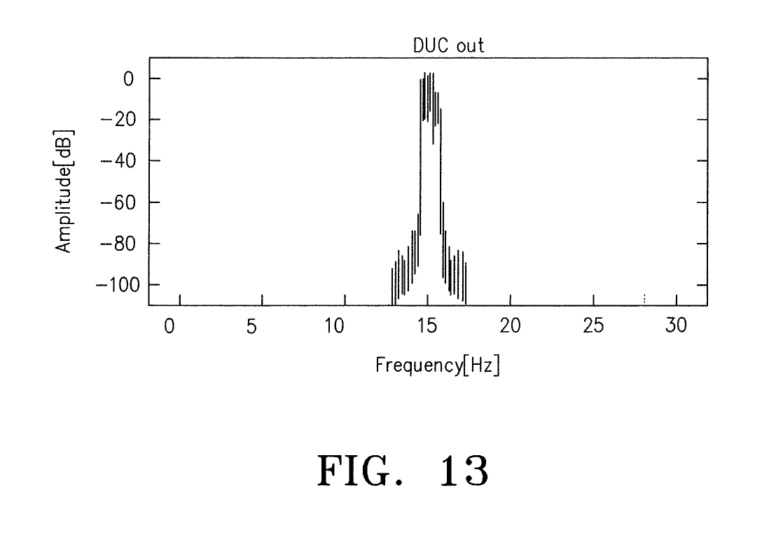

The output of the complex BPF (interpolation BPF) is subjected to frequency conversion to a target frequency and conversion to a real signal by the second mixer 1140, and then output as an RF or IF signal by the D/A converter. According to the simulation, since the spurious level of the second DDS 1132 illustrated in FIG. 12 is below −100 dBc, the output of the digital up-converter 1160 illustrated in FIG. 13 has a considerably excellent spurious characteristic. Here, the spurious characteristic is a characteristic obtained by frequency shifting the first IF signal.

The simulation results of the transmitter according to the present invention, illustrated in FIGS. 9 to 13, are obtained when sampling frequencies are Fs1=Fs2=64 Hz; the first DDS 1103 having a phase operation word length of 32 bits, a ROM size of 1K words, and a ROM output bit length of 16 bits was used as the first local signal generator; the spurious signal output from the first mixer 1110 is suppressed by the complex BPF with a stop band attenuation of about 40 dB; and the spurious suppressed signal is converted to the target frequency by the second DDS 1132 having a phase operation word length of 5 bits, a ROM size of 32 words, a ROM output bit length of 16 bits. It can be understood from FIG. 13 that the spurious signal set apart from the signal frequency of the digital up-converter is completely suppressed.

In this second embodiment, the output of the digital up-converter 1160 may be a complex output. Further, the frequency Fif1 may be an arbitrary frequency determined by adding the output frequency Fif2 of the digital up-converter 1160 to the difference frequency that cannot be converted by the second DDS 1132.

Further, in the second embodiment, the reference LPF 131 has the same characteristic as the roll-off filters 1101 and 1102. It is possible to omit the roll-off filters 1101 and 1102 by utilizing a frequency synthesizer capable of setting a frequency step for frequency shifting of the filter coefficient. Here, the set frequency step is a frequency step subdivided by the first DDS 1103 rather than the second DDS 1132.

In addition, unless the spurious characteristic of the first DDS 1103 deteriorates the stop band characteristic of the interpolation bandpass filter 1120 below a permissible level, it is possible to perform frequency shifting using the first DDS 1103.

As described above, the first embodiment of the present invention remarkably reduces the spurious level of the transmission signal caused by the spurious signals from the local signal generators without increasing the power consumption of the digital signal processor. Further, it is possible to simplify the structure of the second DDS constituting the second local signal generator providing the second mixer 1140 with the local oscillation signals, increase the sampling frequency and improve performance of the PLL using the output signal of the second DDS as a reference signal.

Further, the second embodiment of the present invention remarkably reduces the effects of the spurious signal from the frequency synthesizer by digital signal processing and thus, implements a digital up-converter with low power consumption, without increasing the power consumption caused by an increase in the ROM size. In addition, the second embodiment simplifies the structure of the second DDS serving as the second local signal generator, thereby increasing the output sampling frequency of the digital up-converter. Moreover, the second embodiment does not require an analog filter for suppressing the spurious signal output from the digital up-converter and has an excellent analog filter characteristic due to an increase in the sampling frequency, thus contributing to a reduction in the cost of the transmitter constituting the digital up-converter according to the present invention.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A transmitter used for data communication, comprising:
a first mixer for converting an output of a modulator to a first IF (Intermediate Frequency) signal using a first local signal generator;
a digital filter for suppressing a predetermined out-band signal among the first IF signal; and
a second mixer for D/A (Digital-to-Analog)-converting an output of the digital filter, and converting the D/A-converted signal to a second analog IF signal or RF (Radio Frequency) signal using a second local signal generator;
wherein a frequency step of the first local signal generator is less than a frequency step of the second local signal generator.

2. The transmitter as claimed in claim 1, wherein the second local signal generator is comprised of a DSP (Digital Signal Processing)-based signal generator, and a PLL (Phase Locked Loop) operating based on an output of the signal generator.

3. The transmitter as claimed in claim 2, wherein the DSP-based signal generator constituting the first local signal generator and the second local signal generator is a direct digital synthesizer (DDS) outputting sine/cosine waves.

4. The transmitter as claimed in claim 3, wherein a phase operation word length of the direct digital synthesizer constituting the second local signal generator is equal to an input word length of a sine/cosine wave table for converting phase data to sine/cosine waves.

5. The transmitter as claimed in claim 2, wherein the DSP-based signal generator of the second local signal generator sequentially reads a sine/cosine wave table for converting phase data to sine/cosine waves.

6. The transmitter as claimed in claim 5, wherein the sine/cosine wave table has a variable length.

7. The transmitter as claimed in claim 5, wherein the sine/cosine wave table stores data of multiple periods.

8. The transmitter as claimed in claim 1, wherein the digital filter is an interpolation filter.

9. The transmitter as claimed in claim 1, wherein the digital filter is a complex FIR (Finite Impulse Response) filter, wherein a complex BPF (Band Pass Filter) coefficient for the complex FIR filter is calculated by multiplying a reference LPF (Low Pass Filter) coefficient of a real coefficient having a half bandwidth of a communication channel by e^{j(nω)} where ω denotes an IF frequency of the first mixer, during frequency setup.

10. The transmitter as claimed in claim 9, wherein when a stop band characteristic on the output of the first mixer at the filter can be bad and a passband frequency is not strictly calculated, e^{j(nω)} value multiplied by the LPF coefficient is calculated by the first local signal generator.

11. The transmitter as claimed in claim 9, wherein when a stop band characteristic on the output of the first mixer at the filter must be good and a passband frequency is not strictly calculated, the e^{j(nω)} value multiplied by the LPF coefficient is calculated by the second local signal generator.

12. The transmitter as claimed in claim 2, wherein a sampling clock of the DSP-based signal generator in the second local signal generator is an output of a crystal signal generator.

13. A digital up-converter in a transmitter used for data communication, comprising:
a first mixer for converting an input signal to a first IF signal using a first local signal generator;
a digital filter for suppressing a predetermined out-band signal among the first IF signal; and
a second mixer for converting an output of the digital filter to an input frequency to an A/D converter using a second local signal generator;
wherein a frequency step of the first local signal generator is less than a frequency step of the second local signal generator.

14. The digital up-converter as claimed in claim 13, wherein the first local signal generator and the second local signal generator each are comprised of a direct digital synthesizer (DDS) outputting sine/cosine waves.

15. The digital up-converter as claimed in claim 14, wherein a phase operation word length of the DDS serving as the second local signal generator is equal to an input word length of a sine/cosine wave table for converting phase data to sine/cosine wave.

16. The digital up-converter as claimed in claim 13, wherein the second local signal generator sequentially reads a sine/cosine wave table for converting phase data to sine/cosine waves.

17. The digital up-converter as claimed in claim 16, wherein the sine/cosine wave table has a variable length.

18. The digital up-converter as claimed in claim 16, wherein the sine/cosine wave table stores data of multiple periods.

19. The digital up-converter as claimed in claim 13, wherein sampling frequency conversion is performed between the first mixer and the second mixer.

20. The digital up-converter as claimed in claim 19, wherein the digital filter is an interpolation filter, and increases a sampling frequency after the second mixer.

21. The digital up-converter as claimed in claim 13, wherein a bandwidth of the digital filter is calculated by adding an output frequency step of the second local signal generator to a bandwidth of a communication channel.

22. The digital up-converter as claimed in claim 13, wherein the digital filter is a complex FIR filter, wherein a complex BPF coefficient for the complex FIR filter is calculated by multiplying a reference LPF coefficient of a real coefficient having a half bandwidth of a communication channel by e^{j(nω)}, where ω denotes an IF frequency of the first mixer, during frequency setup.

23. The digital up-converter as claimed in claim 22, wherein when a stop band characteristic on the output of the first mixer at the filter can be bad and a passband frequency is not strictly calculated, the e^{j(nω)} value multiplied by the LPF coefficient is calculated by the first local signal generator.

24. The digital up-converter as claimed in claim 22, wherein when a stop band characteristic on the output of the first mixer at the filter must be good and a passband frequency is not strictly calculated, the e^{j(nω)} value multiplied by the LPF coefficient is calculated by the second local signal generator.
